(19) United States
(12) Patent Application Publication
(10) Pub. No.: US 2020/0074213 A1
(43) Pub. Date: Mar. 5, 2020

(54) GPB ALGORITHM BASED OPERATION AND MAINTENANCE MULTI-MODAL DECISION SYSTEM PROTOTYPE

(71) Applicant: Shanghai DataCenter Science Co., LTD, Shanghai (CN)

(72) Inventors: Jun ZHANG, Shanghai (CN); Xiaofeng CHEN, Shanghai (CN); Jianrong DAI, Shanghai (CN)

(21) Appl. No.: 15/740,964

(22) PCT Filed: Aug. 9, 2017
(86) PCT No.: PCT/CN2017/096517

§ 371 Date: Nov. 21, 2019

(30) Foreign Application Priority Data
Jun. 30, 2017 (CN) 201710518881.X

(51) Int. Cl. G06K 9/62; G06F 17/16

(52) U.S. Cl. CPC G06K 9/623; G06F 17/16; G06K 9/6293

(57) ABSTRACT

The present invention discloses a GPB algorithm based operation and maintenance multi-modal decision system prototype, comprising the following steps: respectively sampling a sensor model and a camera model according to k-1 moment; respectively sampling a sensor model and a camera model according to k moment; conducting respective state estimations by using a Kalman algorithm and estimating an error covariance matrix; then computing synthesis of the state estimations and a corresponding covariance matrix; finally, integrally outputting the state estimations and covariance; and building a GPB algorithm based operation and maintenance multi-modal decision system prototype, so as to realize automatic early warning and prevention of accidents.

### TECHNICAL FIELD

The present invention relates to a GPB algorithm based operation and maintenance multi-modal decision system prototype.

### BACKGROUND

With cloud computing and virtualization, the characteristics of “large scale”, “high density”, “high energy consumption”, “complexity”, etc. are presented. Construction and development of a new generation of data center and improvement of infrastructure management of the data center will become increasingly important. Integrated management and intelligence of an infrastructure architecture of the data center will become a new trend of development of the data center.

At present, operation and maintenance lack of an automation means. Passive operation and maintenance has low efficiency. Large-scale IT facilities bring management pressure. Automatic monitoring for the data center needs to be realized, so as to enhance timely alarm capability of system and environmental parameters and enhance response speed and monitoring levels of system and environmental anomalous change. A unified service management software platform can be realized by using various means such as a sensor, a camera, etc. to perceive information.

Multisource information integration acquires the information through data generated by a perception component. Information integration involves many different perceptors and different executors. Different perception devices can generate different kinds of data. How to effectively integrate the multi-modal data to correctly reflect operation and maintenance states is an very important research topic.

A sensor subsystem is an environment detection apparatus and acts to detect environment change in real time and provide related data for a data integration subsystem. A decision support subsystem uses a data integration structure to estimate situations in time, thereby providing an important basis for sensor management. A sensor management subsystem regulates and optimizes sensor resources in real time according to feedback information supplied in previous phases.

Target detection by the camera is as follows: a target state is used as an initial tracking state; meanwhile, the target is modeled, and relevant features are acquired to construct a descriptive model of the target; then a current state of the target is estimated by using a target model in a subsequent image in a filtering mode; and meanwhile, the target model is updated by using the current state.

Optimal estimation of a fixed model set is full hypothesis estimation, i.e., all possible modes of the system at each moment are considered. The model set is predetermined, no matter whether the model is time-varying. Therefore, it is necessary to establish a more effective non-hypothesis tree algorithm by using some hypothesis management technologies, so as to ensure that the number of rest hypotheses is within a certain range. The so-called generalized false Bayes method (GPB) is to only consider a history of the target model within past limited sampling time intervals of the system when the system state is estimated at k moment.

The present invention provides a GPB algorithm based operation and maintenance multi-modal decision system prototype, comprising the following steps: respectively sampling a sensor model and a camera model according to k-1 moment; respectively sampling a sensor model and a camera model according to k moment; conducting respective state estimations by using a Kalman algorithm and estimating an error covariance matrix; then computing synthesis of the state estimations and a corresponding covariance matrix; finally, integrally outputting the state estimations and covariance; and building a GPB algorithm based operation and maintenance multi-modal decision system prototype, so as to realize automatic early warning and prevention of accidents.

### SUMMARY

The purpose of the present invention is to provide a GPB algorithm based operation and maintenance multi-modal decision system prototype. The present invention comprises the following features:

Technical solution of the invention

1. A GPB algorithm based operation and maintenance multi-modal decision system architecture comprises the following steps:
1) respectively sampling a sensor model and a camera model according to k−1 moment;
2) respectively sampling a sensor model and a camera model according to k moment;
3) conducting respective state estimations by using a Kalman algorithm and estimating an error covariance matrix;
4) then computing synthesis of the state estimations and a corresponding covariance matrix; and
5) finally, integrally outputting the state estimations and covariance.

2. In the architecture according to claim 1, a GPB algorithm based operation and maintenance multi-modal decision system prototype is built.

### DESCRIPTION OF DRAWINGS

FIG. 1 is a diagram of a GPB algorithm based operation and maintenance multi-modal decision system prototype.

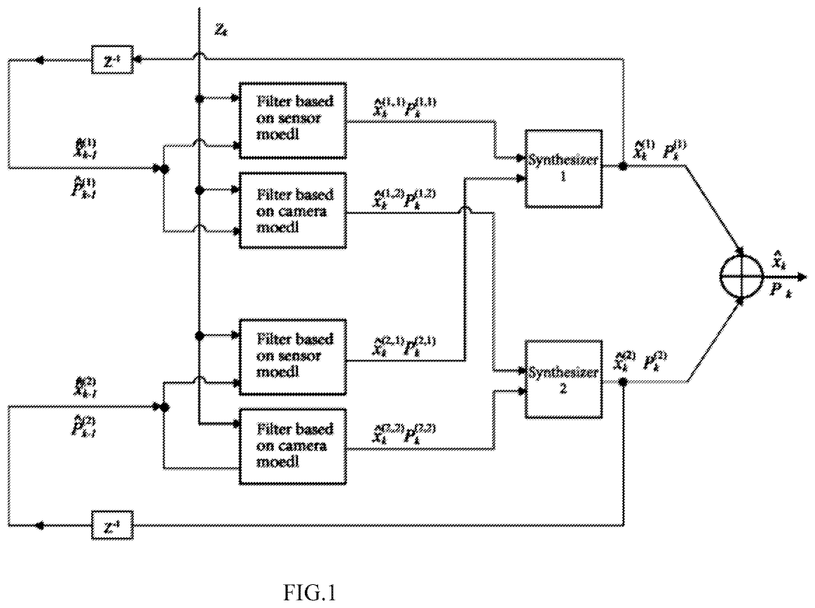

### DETAILED DESCRIPTION

A GPB algorithm based operation and maintenance multi-modal decision system prototype comprises the following steps:
1) respectively sampling a sensor model and a camera model according to k−1 moment;
2) respectively sampling a sensor model and a camera model according to k moment;
3) conducting respective state estimations by using a Kalman algorithm and estimating an error covariance matrix;
4) then computing synthesis of the state estimations and a corresponding covariance matrix;
5) finally, integrally outputting the state estimations and covariance; and
6) building a GPB algorithm based operation and maintenance multi-modal decision system prototype.

1. A GPB algorithm based operation and maintenance multi-modal decision system architecture, comprising the following steps:
1) respectively sampling a sensor model and a camera model according to k−1 moment;
2) respectively sampling a sensor model and a camera model according to k moment;
3) conducting respective state estimations by using a Kalman algorithm and estimating an error covariance matrix;
4) then computing synthesis of the state estimations and a corresponding covariance matrix; and
5) finally, integrally outputting the state estimations and covariance.

2. The architecture according to claim 1, wherein a GPB algorithm based operation and maintenance multi-modal decision system prototype is built.
